(19) United States
(12) Patent Application Publication
(10) Pub. No.: US 2024/0154791 A1
(43) Pub. Date: May 9, 2024

(54) ELECTRONIC DEVICE, METHOD OF CONTROLLING ELECTRONIC DEVICE, AND PROGRAM

(71) Applicant: Sharp NEC Display Solutions, Ltd., Tokyo (JP)

(72) Inventor: Masakazu KOBAYASHI, Tokyo (JP)

(21) Appl. No.: 18/416,060

(22) Filed: Jan. 18, 2024

Related U.S. Application Data
(63) Continuation of application No. PCT/JP2021/033731, filed on Sep. 14, 2021.

(51) Int. Cl. H04L 9/08; H04L 9/30

(52) U.S. Cl. CPC H04L 9/0825; H04L 9/0894; H04L 9/3073

(57) ABSTRACT

An electronic device is an electronic device provided with at least two substrates, including: a device information acquisition unit that acquires a first identifier and a second identifier from each of the two substrates and acquires a third identifier from a database; a determination unit that determines whether each of the two substrates is a replaced substrate on the basis of whether the first identifier and the second identifier are the same as the third identifier; and an update unit that updates first maintenance information stored in a substrate determined by the determination unit to be a replaced substrate with second maintenance information stored in a substrate determined by the determination unit not to be a replaced substrate.

### TECHNICAL FIELD

The present invention relates to an electronic device, a method of controlling an electronic device, and a program.

### BACKGROUND ART

Since the past, electronic devices have each been given a unique identifier (such as, for example, a serial number or a manufacturing number), which have been used for management such as manufacturing, distribution, sales, maintenance, and repair of electronic devices. A label on which an identifier is printed is attached to each electronic device at the time of shipment. Confirmation of the correct identifier may not always be possible when a label is simply attached to an electronic device due to loss of the label caused by peeling off or intentional switching of the label. In addition, depending on the installation position of an electronic device and the attachment position of a label, the label may not be visible and the identifier may not be able to be confirmed. Thus, the inability to confirm the identifier may cause a hindrance in the management of the electronic device. Therefore, for example, an identifier is pre-installed in a non-volatile memory provided on a substrate in an electronic device at the time of shipment. This allows a manager to perform management on the basis of the identifier stored in the non-volatile memory regardless of whether the label is present or correct.

However, in a case where a substrate provided with a non-volatile memory that stores an identifier is replaced due to repair, a non-volatile memory of a newly provided substrate does not store an identifier of an electronic device, which causes hindrance in management after repair.

Consequently, various techniques for storing an identifier of an electronic device in a non-volatile memory of a newly provided substrate have been proposed.

For example, the following Patent Literature 1 discloses a technique in which an identifier of an electronic device is stored in advance in a host computer, and when a non-volatile memory having the identifier stored therein is replaced after the shipment of the electronic device, the identifier can be installed from the host computer into a newly provided non-volatile memory.

### CITATION LIST

### Patent Literature

### Patent Literature 1

Japanese Unexamined Patent Application, First Publication No. 2007-122106

### SUMMARY OF INVENTION

### Technical Problem

However, in an electronic device that is made redundant by including a plurality of substrates provided with a non-volatile memory, when any of the substrates is replaced, the technique disclosed in Patent Literature 1 cannot distinguish which substrate is a newly provided substrate, which results in the inability to correctly install an identifier of the electronic device on the newly provided substrate.

In addition, the non-volatile memory provided on the substrate may store information other than the identifier (such as, for example, information indicating the status of use of the substrate or information on maintenance). Therefore, when a substrate is replaced, it is desirable for each piece of information stored in the non-volatile memory of the substrate to be replaced to be able to be transferred to the non-volatile memory of the newly provided substrate.

However, as described above, the technique disclosed in Patent Literature 1 cannot distinguish which substrate is a newly provided substrate, and thus each piece of information stored in the non-volatile memory of the substrate to be replaced cannot be transferred to the non-volatile memory of the newly provided substrate.

In view of the above problems, an object of the present invention is to provide an electronic device, a method of controlling an electronic device, and a program that, when any of substrates in an electronic device including a plurality of substrates provided with a non-volatile memory is replaced, make it possible to transfer information stored in the non-volatile memory provided on the substrate to be replaced to the non-volatile memory provided on the newly provided substrate.

### Solution to Problem

In order to solve the above-described problem, according to an aspect of the present invention, there is provided an electronic device provided with at least two substrates, including: a device information acquisition unit that acquires a first identifier and a second identifier from each of the two substrates and acquires a third identifier from a database; a determination unit that determines whether each of the two substrates is a replaced substrate on the basis of whether the first identifier and the second identifier are the same as the third identifier; and an update unit that updates first maintenance information stored in a substrate determined by the determination unit to be a replaced substrate with second maintenance information stored in a substrate determined by the determination unit not to be a replaced substrate.

According to an aspect of the present invention, there is provided a method of controlling an electronic device provided with at least two substrates, the method including: a device information acquisition step of causing a device information acquisition unit to acquire a first identifier and a second identifier from each of the two substrates and acquire a third identifier from a database; a determination step of causing a determination unit to determine whether each of the two substrates is a replaced substrate on the basis of whether the first identifier and the second identifier are the same as the third identifier; and an update step of causing an update unit to update first maintenance information stored in a substrate determined by the determination unit to be a replaced substrate with second maintenance information stored in a substrate determined by the determination unit not to be a replaced substrate.

According to an aspect of the present invention, there is provided a program for causing a computer to function as an electronic device provided with at least two substrates, the program causing the computer to function as: a device information acquisition unit that acquires a first identifier and a second identifier from each of the two substrates and acquires a third identifier from a database; a determination unit that determines whether each of the two substrates is a replaced substrate on the basis of whether the first identifier and the second identifier are the same as the third identifier; and an update unit that updates first maintenance information stored in a substrate determined by the determination unit to be a replaced substrate with second maintenance information stored in a substrate determined by the determination unit not to be a replaced substrate.

### Advantageous Effects of Invention

According to the present invention, when any of substrates in an electronic device including a plurality of substrates provided with a non-volatile memory is replaced, it is possible to transfer information stored in the non-volatile memory provided on the substrate to be replaced to the non-volatile memory provided on the newly provided substrate.

### BRIEF DESCRIPTION OF DRAWINGS

FIG. 1 is a diagram illustrating an overview of a digital cinema projector according to the present embodiment.

FIG. 2 is a diagram illustrating an example of a data configuration of device information according to the present embodiment.

FIG. 3 is a block diagram illustrating an example of a configuration of the digital cinema projector according to the present embodiment.

FIG. 4 is a block diagram illustrating an example of a functional configuration of an image media block (IMB) according to the present embodiment.

FIG. 5 is a block diagram illustrating an example of a functional configuration of a control unit of the digital cinema projector according to the present embodiment.

FIG. 6 is a sequence diagram illustrating an example of a validity determination process of the IMB according to the present embodiment.

FIG. 7 is a sequence diagram illustrating an example of a validity determination process of device information according to the present embodiment.

FIG. 8 is a flowchart illustrating an example of an update process according to the present embodiment.

FIG. 9 is a block diagram illustrating an electronic device with a minimum configuration according to the present embodiment.

### DESCRIPTION OF EMBODIMENTS

Hereinafter, an embodiment according to the present invention will be described in detail with reference to the accompanying drawings.

An electronic device according to the present embodiment is a device including at least two substrates. The electronic device is, for example, a projector. In addition, the electronic device according to the present embodiment is a device including a video device that receives or outputs at least video content (hereinafter also simply referred to as “content”). The video device is, for example, an image media block (IMB). That is, the electronic device according to the present embodiment is a projector including an IMB. The projector including an IMB is, for example, a digital cinema projector used in a theater such as a movie theater.

The substrate included in the electronic device is, for example, a printed wiring board (PWB). The number of substrates included in the electronic device is not particularly limited insofar as it is at least two, and may be, for example, three or four. Each of the substrates included in the electronic device in the present embodiment is equipped with a non-volatile memory.

In the following embodiment, an example in which the electronic device is a digital cinema projector including an IMB and two PWBs will be described.

### <1. Overview of Digital Cinema Projector>

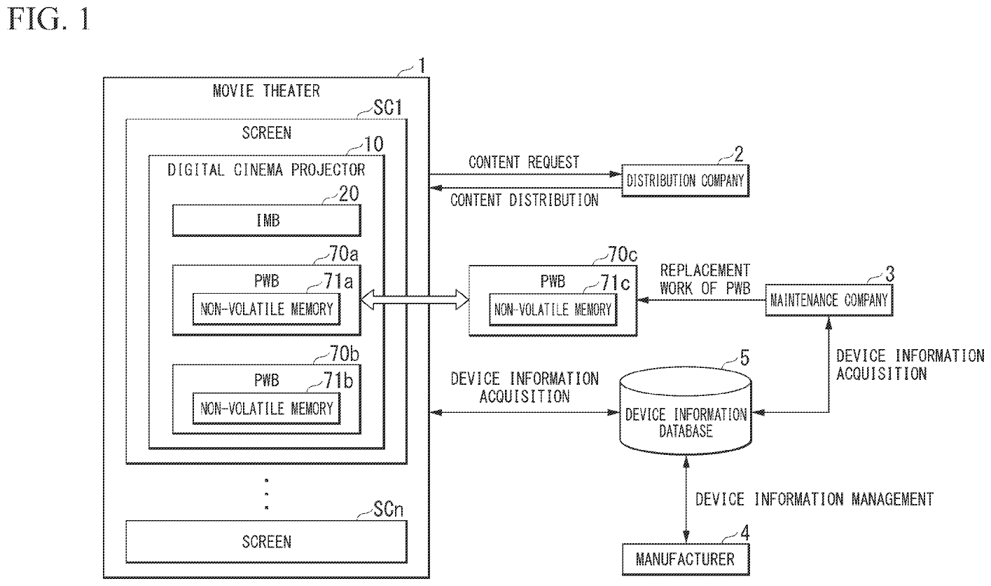

First, an overview of a digital cinema projector according to the present embodiment will be described with reference to FIG. 1. FIG. 1 is a diagram illustrating an overview of a digital cinema projector according to the present embodiment. An example in which the digital cinema projector is used in a movie theater will be described below.

As shown in FIG. 1, a movie theater 1 is provided with n screens SC1 to SCn (n is a natural number). Each of the screens SC1 to SCn is provided with a digital cinema projector 10.

The digital cinema projector 10 is a device that projects content such as movies onto a screen. A label (not shown) on which the serial number of the digital cinema projector 10 is printed is attached to the housing of the digital cinema projector 10. The serial number of the digital cinema projector 10 is an example of an identifier of the digital cinema projector 10 (an identifier of an electronic device). Meanwhile, the identifier of the digital cinema projector 10 is not limited to the serial number, and may be, for example, a manufacturing number or the like.

As shown in FIG. 1, the digital cinema projector 10 includes an IMB 20, a PWB 70a, and a PWB 70b.

The BIB 20 is a device that reproduces content and is built into the digital cinema projector 10. The content reproduced by the IMB 20 is projected from the digital cinema projector 10 onto the screen. The BIB 20 has a storage that stores various types of information. For example, the IMB 20 stores content, a certificate containing a public key, a private key paired with the public key, and the serial number of the IMB 20 in its storage. The IB 20 can decrypt content and information encrypted by the public key with the private key. The serial number of the IMB 20 is an example of an identifier of an IMB (an identifier of a video device). Meanwhile, the identifier of an BIB is not limited to the serial number, and may be, for example, a manufacturing number or the like.

The movie theater 1 requests content to be shown on each screen from a distribution company 2 and receives the content. In this case, the movie theater 1 provides the distribution company 2 with the serial number of the digital cinema projector 10 provided on each screen, the serial number of the IMB 20, and a certificate.

The distribution company 2 selects content corresponding to each serial number provided by the movie theater 1 and encrypts the selected content using the public key in the certificate. Specifically, the distribution company 2 first encrypts the content with the content key, and then encrypts the content key used for encryption with the public key. The distribution company 2 then distributes the content that has been encrypted (hereinafter also referred to as “encrypted content”) and the content key that has been encrypted (hereinafter also referred to as “encrypted content key”) to the movie theater 1.

The encrypted content and the encrypted content key distributed from the distribution company 2 are stored in the storage in the IMB 20 built into the digital cinema projector 10 provided on the screen on which the content is shown. The IMB 20 first decrypts the distributed encrypted content key using the private key stored in the storage. Next, the IMB 20 decrypts the encrypted content using the content key that has been decrypted (hereinafter also referred to as “decrypted content key”). The digital cinema projector 10 reproduces then the content decrypted by the IMB 20 (hereinafter also referred to as “decrypted content”) and projects it onto the screen. In this way, the distribution company 2 can safely distribute the content to the movie theater 1 by using encryption.

A maintenance company 3 is a company that maintains the digital cinema projector 10. For example, the maintenance company 3 performs replacement work on the PWB 70a or the PWB 70b provided in the digital cinema projector 10. In the present embodiment, the PWB 70a included in the digital cinema projector 10 is replaced with a PWB 70c included in another digital cinema projector (not shown).

The PWB 70a, the PWB 70b, and the PWB 70c are substrates provided with a non-volatile memory. The non-volatile memory is, for example, an electrically erasable programmable read-only memory (EEPROM).

As shown in FIG. 1, the PWB 70a, the PWB 70b, and the PWB 70c are provided with a non-volatile memory 71a, a non-volatile memory 71b, and a non-volatile memory 71c, respectively. Hereinafter, in a case where the PWB 70a, the PWB 70b, and the PWB 70c need not be distinguished from each other, the PWB 70a, the PWB 70b, and the PWB 70c are collectively referred to as the “PWB 70.” In addition, in a case where the non-volatile memory 71a, the non-volatile memory 71b, and the non-volatile memory 71c need not be distinguished from each other, the non-volatile memory 71a, the non-volatile memory 71b, and the non-volatile memory 71c are collectively referred to as the “non-volatile memory 71.”

Maintenance information relating to the maintenance of the digital cinema projector 10 is stored in the non-volatile memory 71. The maintenance information includes, for example, the serial number of the digital cinema projector 10 and the usage time of the digital cinema projector 10. The serial number of the digital cinema projector 10 included in the maintenance information is a serial number printed on a label attached to the housing, and is pre-installed in both the non-volatile memory 71a and the non-volatile memory 71b at the time of shipment. The usage time is simultaneously written in both the non-volatile memory 71a and the non-volatile memory 71b with the elapse of the usage time of the digital cinema projector 10.

Meanwhile, in the present embodiment, the serial number of the digital cinema projector 10 included in the maintenance information pre-installed in the non-volatile memory 71 provided in each of the two PWBs 70 included in the digital cinema projector 10 is a first identifier or a second identifier. For example, the digital cinema projector 10 is assumed to be provided with the PWB 70a and the PWB 70b before the replacement work. In this case, the serial number of the digital cinema projector 10 included in the maintenance information pre-installed in the non-volatile memory 71a of the PWB 70a is used as a first identifier, and the serial number of the digital cinema projector 10 included in the maintenance information pre-installed in the non-volatile memory 71b of the PWB 70b is used as a second identifier. In addition, the digital cinema projector 10 is assumed to be provided with the PWB 70b and the PWB 70c after the replacement work. In this case, the serial number of the digital cinema projector 10 included in the maintenance information pre-installed in the non-volatile memory 71b of the PWB 70b is used as a first identifier, and the serial number of the digital cinema projector 10 included in the maintenance information pre-installed in the non-volatile memory 71c of the PWB 70c is used as a second identifier.

In the present embodiment, the maintenance company 3 performs the replacement work on the PWB 70 using the information stored in a database managed by a manufacturer 4 of the digital cinema projector 10. Specifically, the manufacturer 4 manages device information including at least the serial number of the digital cinema projector 10 in a device information database 5. Persons associated with the movie theater 1 and the maintenance company 3 can access the device information database 5 to acquire the device information.

Meanwhile, in the present embodiment, the serial number of the digital cinema projector 10 included in the device information managed in the device information database 5 is assumed to be a third identifier. Meanwhile, in the device information database 5, the serial number of the digital cinema projector 10 which is a third identifier and the serial number of the IMB 20 which is an identifier of the video device are associated with each other.

In performing the replacement work on the PWB 70, the operator of the maintenance company 3 downloads the device information of the digital cinema projector 10 to be replaced from the device information database 5 in advance and stores it in a storage medium such as a Universal Serial Bus (USB) memory.

The operator brings the USB memory into the movie theater 1 where the digital cinema projector 10 to be replaced is installed and performs the replacement work. During the replacement work, the operator connects the USB memory to the digital cinema projector 10 to be replaced, installs the device information, and then performs the replacement work on the PWB 70.

### (Data Configuration of Device Information)

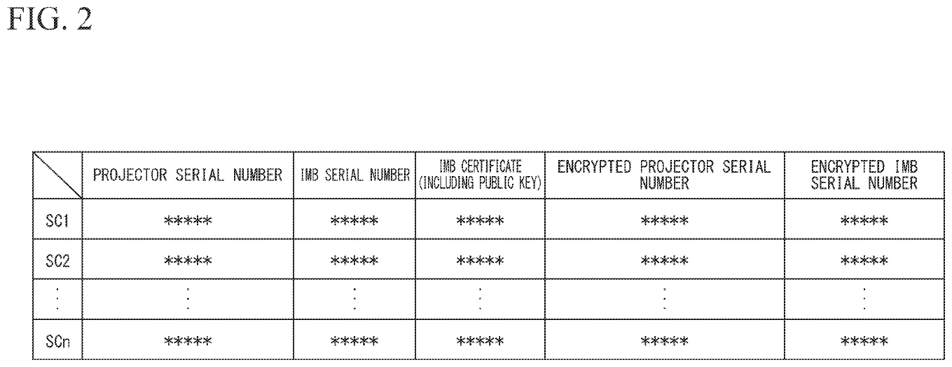

Here, a data configuration of device information will be described with reference to FIG. 2. FIG. 2 is a diagram illustrating an example of a data configuration of device information according to the present embodiment.

As shown in FIG. 2, the device information consists of a data configuration including a projector serial number, an IMB serial number, an IMB certificate, an encrypted projector serial number, and an encrypted IMB serial number.

The projector serial number is the serial number of the digital cinema projector 10. Hereinafter, the projector serial number is also referred to as “PJSN.”

The IB serial number is the serial number of the IMB 20. The serial number of the IMB 20 is an example of the identifier of the IMB. Hereinafter, the IMB number is also referred to as “IMBSN.”

The IB certificate is the certificate of the IMB 20. The IMB certificate contains a public key. Hereinafter, the public key included in the IMB certificate is also referred to as “Kpb.” The private key stored in the storage of the IMB 20 is also referred to as “Kpv.”

The encrypted projector serial number is a projector serial number encrypted with the public key in the IMB certificate. Specifically, the encrypted projector serial number is information in which the projector serial number (third identifier) included in the device information stored in the device information database 5 is encrypted with the public key in the IMB certificate, and is an example of an encrypted electronic device identifier. Hereinafter, the encrypted projector serial number is also referred to as “PJSNa.” Meanwhile, PJSNa may also be referred to as PJSNKpb. PJSNKpb indicates that PJSN is encrypted with Kpb.

The encrypted IMVIB serial number is an IMB serial number encrypted with the public key in the IVIB certificate. Specifically, the encrypted IMB serial number is information in which the serial number of the IMVIB 20 (the identifier of the video device) included in the device information stored in the device information database 5 is encrypted with the public key in the IMB certificate, and is an example of the identifier of the encrypted video device. Hereinafter, the encrypted IMB serial number is also referred to as “IMBSNa.” Meanwhile, IMBSNa may also be referred to as IMBSNKpb. IMBSNKpb indicates that TNVIBSN is encrypted with Kpb.

Referring back to FIG. 1, the digital cinema projector 10 is made redundant by being provided with a plurality of PWBs 70 and non-volatile memories 71. Thereby, even if one PWB 70 out of the PWB 70a and the PWB 70b is replaced due to a failure or maintenance of the digital cinema projector 10, the maintenance information stored in the non-volatile memory 71 provided in the PWB 70 that has not been replaced can be transferred to the non-volatile memory 71 provided in the newly provided PWB 70. By repeating the same process each time the PWB 70 is replaced, the serial number and usage time of the digital cinema projector 10 remain in the digital cinema projector 10 forever.

In addition, by using the device information installed during replacement of the PWB 70, the digital cinema projector 10 can correctly determine which of the plurality of PWBs 70 is a PWB 70 newly provided through the replacement work and which PWB 70 is a PWB 70 provided before the replacement work.

As described above, in the present embodiment, the PWB 70a included in the digital cinema projector 10 is replaced with the PWB 70c included in another digital cinema projector. Therefore, maintenance information of another digital cinema projector is stored in the non-volatile memory 71c provided in the PWB 70c newly provided in the digital cinema projector 10 by replacement.

Consequently, after the PWB 70 is replaced, the digital cinema projector 10 compares the projector serial number of the maintenance information stored in the non-volatile memory 71 provided in each PWB 70 with the projector serial number of the installed device information. In a case where the serial numbers match, the digital cinema projector 10 can determine that the PWB 70 to be compared is a PWB 70 that has been provided before the replacement work (that is, a PWB 70 that has not been replaced). On the other hand, in a case where the serial numbers do not match, the digital cinema projector 10 can determine that the PWB 70 to be compared is a PWB 70 newly provided through the replacement work (that is, a PWB 70 that has been replaced).

Thereby, the digital cinema projector 10 can correctly transfer the maintenance information the newly provided PWB 70c.

Further, the device information used by the digital cinema projector 10 is managed by the manufacturer 4 and is also encrypted information. Further, the encryption of the device information is configured so that it can be decrypted only by the IMB 20 having the private key. Therefore, there is no risk of the device information being falsified by a person in charge of the maintenance company 3 with malicious intent. This also makes it possible to prevent spoofing of the digital cinema projector 10 and falsification of information.

### <2. Configuration of Digital Cinema Projector>

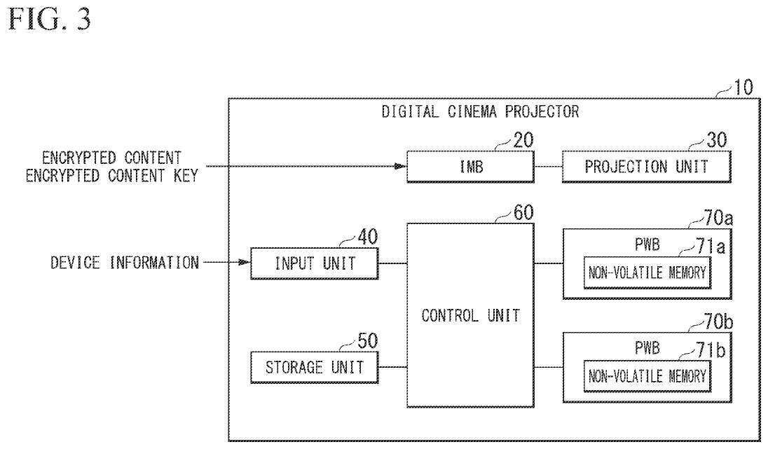

An overview of the digital cinema projector 10 according to the present embodiment has been described above. Subsequently, the configuration of the digital cinema projector 10 according to the present embodiment will be described with reference to FIG. 3. FIG. 3 is a block diagram illustrating an example of the configuration of the digital cinema projector according to the present embodiment.

As shown ibn FIG. 3, the digital cinema projector 10 includes the IMB 20, a projection unit 30, an input unit 40, a storage unit 50, a control unit 60, the PWB 70a, and the PWB 70b.

### (1) IMB 20

The IMB 20 has a function of reproducing content distributed from the distribution company 2 and a function of decrypting various types of information. For example, the encrypted content and the encrypted content key distributed from the distribution company 2 are input to the IB 20. The IMB 20 decrypts the encrypted content key with the private key to acquire the decrypted content key, and decrypts the encrypted content with the decrypted content key to acquire the decrypted content. The IB 20 reproduces the acquired content and outputs a video signal of the reproduced content to the projection unit 30. In addition, the IB 20 is connected to the control unit 60 so as to be capable of inputting and outputting various types of information.

The details of the functions of the IMB 20 will be described later.

### (2) Projection Unit 30

The projection unit 30 has a function of projecting a video signal. For example, the projection unit 30 projects the video signal having undergone video signal processing output from the IMB 20 onto the screen.

### (3) Input Unit 40

The input unit 40 has a function of accepting input of various types of information. As an example, the input unit 40 is realized by an interface such as, for example, a USB port. In this case, the input unit 40 accepts input of device information stored in the USB memory connected by an operator of the maintenance company 3. The input unit 40 outputs the accepted device information to the control unit 60. In addition, the input unit 40 may write the accepted device information to the storage unit 50 and store it.

### (4) Storage Unit 50

The storage unit 50 has a function of storing various types of information used by the digital cinema projector 10. The storage unit 50 is constituted by a storage medium, for example, a hard disk drive (HDD), a solid state drive (SSD), a flash memory, an EEPROM, a random access read (RAM/write memory), a read only memory (ROM), or any combination of these storage media.

### (6) Control Unit 60

The control unit 60 has a function of controlling the overall operation of the digital cinema projector 10. The control unit 60 is realized, for example, by causing a central processing unit (CPU) included as hardware in the digital cinema projector 10 to execute a program. The CPU is provided, for example, on a substrate different from the PWB 70.

The details of the functions of the control unit 60 will be described later.

### (7) PWB 70a, PWB 70b

The PWB 70a is provided with the non-volatile memory 71a, and the PWB 70b is provided with the non-volatile memory 71b. The PWB 70a and the PWB 70b are connected to the control unit 60 so as to be capable of inputting and outputting various types of information. Thereby, the control unit 60 can read the maintenance information stored in the non-volatile memory 71 provided in each PWB 70.

### <3. Functional Configuration of EIB>

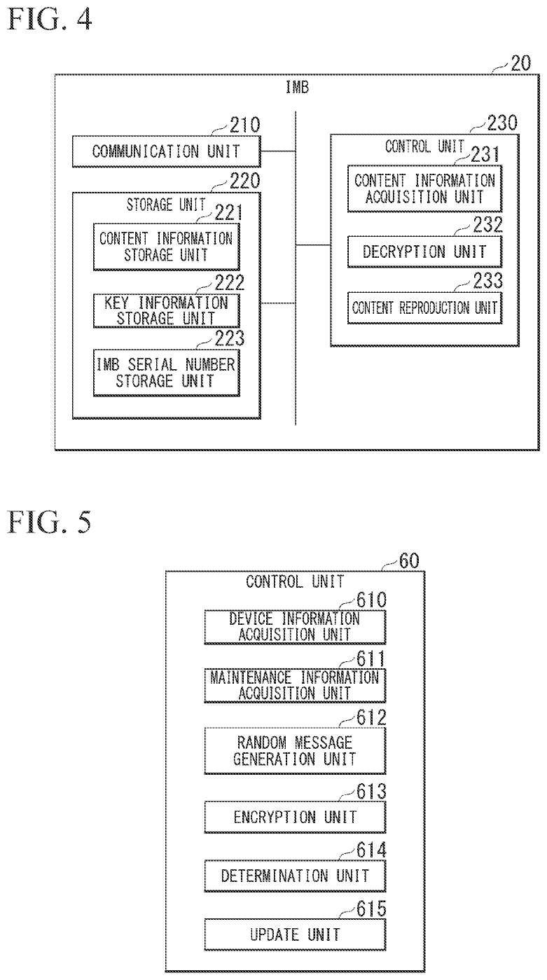

The configuration of the digital cinema projector 10 according to the present embodiment has been described above. Subsequently, the functional configuration of the IMB 20 according to the present embodiment will be described with reference to FIG. 4. FIG. 4 is a block diagram illustrating an example of the functional configuration of the IMB 20 according to the present embodiment.

As shown in FIG. 4, the IMB 20 includes a communication unit 210, a storage unit 220, and a control unit 230.

### (1) Communication Unit 210

The communication unit 210 has a function of transmitting and receiving various types of information. For example, the communication unit 210 receives the encrypted content and the encrypted content key distributed from the distribution company 2.

The communication unit 210 writes the received encrypted content and encrypted content key to the storage unit 220 and stores them.

### (2) Storage Unit 220

The storage unit 220 has a function of storing various types of information used by the IMB 20. The storage unit 240 is constituted by a storage medium, for example, an HDD, an SSD, a flash memory, an EEPROM, a RAM, a ROM, or any combination of these storage media.

As shown in FIG. 4, the storage unit 220 includes a content information storage unit 221, a key information storage unit 222, and an IB serial number storage unit 223. Meanwhile, the IMB serial number storage unit 223 is an example of an BIB identifier storage unit.

### (2-1) Content Information Storage Unit 221

The content information storage unit 221 has a function of storing content information. The content information is, for example, encrypted content and an encrypted content key. The content information storage unit 221 stores the encrypted content and the encrypted content key received by the communication unit 210.

Meanwhile, the content information stored in the content information storage unit 221 may contain decrypted content obtained by decrypting the encrypted content and a decrypted content key obtained by decrypting the encrypted content key.

### (2-2) Key Information Storage Unit 222

The key information storage unit 222 has a function of storing key information. The key information is, for example, a certificate containing a public key and a private key paired with the public key. Specifically, the key information storage unit 222 stores an IMB certificate which is a certificate of the IMB 20, and a private key paired with the public key in the IMB certificate. The key information is pre-installed in advance, for example, at the time of shipment of the IMB 20.

### (2-3) IB Serial Number Storage Unit 223

The IB serial number storage unit 223 has a function of storing an IMB serial number. The IB serial number is pre-installed in advance, for example, at the time of shipment of the IMB 20.

### (3) Control Unit 230

The control unit 230 has a function of controlling the overall operation of the IMB 20. The control unit 230 is realized, for example, by causing a CPU provided as hardware in the IMB 20 to execute a program.

As shown in FIG. 4, the control unit 230 includes a content information acquisition unit 231, a decryption unit 232, and a content reproduction unit 233.

### (3-1) Content Information Acquisition Unit 231

The content information acquisition unit 231 has a function of acquiring content information. For example, the content information acquisition unit 231 acquires content information stored in the content information storage unit 221 and outputs it to the decryption unit 232.

### (3-2) Decryption Unit 232

The decryption unit 232 has a function of decrypting information encrypted with a public key with a private key paired with the public key. Specifically, the decryption unit 232 decrypts the information encrypted with the public key in the IMB certificate with the private key stored in the key information storage unit 222.

For example, the decryption unit 232 decrypts the content information input from the content information acquisition unit 231. Specifically, the encrypted content and the encrypted content key are assumed to be input to the decryption unit 232. In this case, the decryption unit 232 decrypts the encrypted content key with the private key stored in the key information storage unit 222 to acquire the decrypted content key, and decrypts the encrypted content with the decrypted content key to acquire the decrypted content. The decryption unit 232 outputs the decrypted content to the content reproduction unit 233.

Meanwhile, the decryption unit 232 may write the decrypted content and the decrypted content key to the content information storage unit 221 and store them.

In addition, the decryption unit 232 decrypts various types of information input from the control unit 60.

Specifically, it is assumed that the encrypted projector serial number encrypted with the public key in the IMB certificate is input to the decryption unit 232. In this case, the decryption unit 232 decrypts the encrypted projector serial number with the private key stored in the key information storage unit 222. The decryption unit 232 outputs the decrypted projector serial number (hereinafter also referred to as “decrypted projector serial number”) to the control unit 60. Meanwhile, the decrypted projector serial number is a third identifier.

Hereinafter, the decrypted projector serial number is also referred to as “PJSNb.” Meanwhile, PJSNb may also be referred to as PJSNaKpv. PJSNaKpv indicates that PJSNa has been decrypted with Kpv.

In addition, it is assumed that the encrypted IMB serial number encrypted with the public key in the BIB certificate is input to the decryption unit 232. In this case, the decryption unit 232 decrypts the encrypted IMB serial number with the private key stored in the key information storage unit 222. The decryption unit 232 outputs the decrypted IMB serial number (hereinafter also referred to as “decrypted IMB serial number”) to the control unit 60.

Hereinafter, the decrypted IMB serial number also referred to as “IMBSNb.” Meanwhile, IMBSNb may also be referred to as IMBSNaKpv. IMBSNaKpv indicates that IMBSNa has been decrypted with Kpv.

In addition, it is assumed that an encrypted random message encrypted with the public key in the BIB certificate is input to the decryption unit 232. In this case, the decryption unit 232 decrypts the encrypted random message with the private key stored in the key information storage unit 222. The decryption unit 232 outputs the decrypted random message (hereinafter also referred to as “decrypted random message”) to the control unit 60.

Hereinafter, the decrypted random message is also referred to as “RMb.” Meanwhile, RMb may also be referred to as RMaKpv. RMaKpv indicates that RMa has been decrypted with Kpv.

### (3-3) Content Reproduction Unit 233

The content reproduction unit 233 has a function of reproducing content. For example, the content reproduction unit 233 reproduces the content which is input from the decryption unit 232. The content reproduction unit 233 then outputs a video signal of the reproduced content to the projection unit 30.

### <4. Functional Configuration of Control Unit of Digital Cinema Projector>

The functional configuration of the IMB 20 according to the present embodiment has been described above. Subsequently, the functional configuration of the control unit 60 of the digital cinema projector 10 according to the present embodiment will be described with reference to FIG. 5. FIG. 5 is a block diagram illustrating an example of the functional configuration of the control unit 60 of the digital cinema projector 10 according to the present embodiment.

As shown in FIG. 5, the control unit 60 includes a device information acquisition unit 610, a maintenance information acquisition unit 611, a random message generation unit 612, an encryption unit 613, a determination unit 614, and an update unit 615.

### (1) Device Information Acquisition Unit 610

The device information acquisition unit 610 has a function of acquiring device information. For example, the device information acquisition unit 610 acquires the device information from the device information database 5. Specifically, the device information acquisition unit 610 acquires the device information which is stored in a USB memory from the device information database 5 and which has been input by the input unit 40 from the USB memory. In a case where the device information is stored in the storage unit 50, the device information acquisition unit 610 may acquire the device information from the storage unit 50.

In this way, by acquiring the device information from the device information database 5, the device information acquisition unit 610 acquires the IMB serial number (the identifier of the video device) and the projector serial number (third identifier) associated with the IMB serial number in the device information database 5. The device information acquisition unit 610 outputs the projector serial number and the IMB serial number in information included in the acquired device information to the determination unit 614.

In addition, the device information acquisition unit 610 outputs the encrypted projector serial number and the encrypted IMB serial number in the information included in the acquired device information to the decryption unit 232 of the IMB 20.

In addition, the device information acquisition unit 610 outputs the IMB certificate in the information included in the acquired device information to the encryption unit 613.

In addition, the device information acquisition unit 610 has a function of acquiring the projector serial number stored in each of non-volatile memories 71 provided in each PWB 70 included in the digital cinema projector 10. For example, in a case where any of the plurality of PWBs 70 included in the digital cinema projector 10 is replaced, the device information acquisition unit 610 acquires the projector serial number from each of the non-volatile memories 71 provided in each PWB 70 included in the digital cinema projector 10 after replacement. Specifically, it is assumed that the PWB 70a included in the digital cinema projector 10 is replaced with the PWB 70c included in another digital cinema projector (not shown). In this case, the device information acquisition unit 610 acquires the projector serial number (first identifier) stored in the non-volatile memory 71b of the PWB 70b and the projector serial number (second identifier) stored in the non-volatile memory 71c of the PWB 70c.

The device information acquisition unit 610 outputs each of the acquired projector serial numbers (the first identifier and the second identifier) to the determination unit 614.

### (2) Maintenance Information Acquisition Unit 611

The maintenance information acquisition unit 611 has a function of acquiring maintenance information. For example, the maintenance information acquisition unit 611 acquires the maintenance information from at least any of the non-volatile memories 71 provided in each PWB 70 included in the digital cinema projector 10. Specifically, in a case where any of the plurality of PWBs 70 included in the digital cinema projector 10 is replaced, the maintenance information acquisition unit 611 acquires the maintenance information from the non-volatile memory 71 provided in the PWB 70 that has not been replaced.

The maintenance information acquisition unit 611 outputs the acquired maintenance information to the update unit 615.

### (3) Random Message Generation Unit 612

The random message generation unit 612 has a function of generating a random message. The random message generation unit 612 outputs the generated random message to the encryption unit 613 and the determination unit 614.

### (4) Encryption Unit 613

The encryption unit 613 has a function of encrypting information with a public key. For example, the encryption unit 613 encrypts the random message generated by the random message generation unit 612 with the public key in the IB certificate. The encryption unit 613 outputs the encrypted random message (hereinafter also referred to as “encrypted random message”) to the decryption unit 232 of the IB 20.

Hereinafter, the random message is also referred to as “RM.” In addition, the encrypted random message is also referred to as “RMa.” Meanwhile, RMa may also be referred to as RMKpb. RMKpb indicates that the RM has been encrypted with Kpb.

Meanwhile, when the random message is encrypted, the encryption unit 613 may use the public key in the IB certificate included in the device information, or may use the public key in the IB certificate stored in the key information storage unit 222.

### (5) Determination Unit 614

The determination unit 614 has a function of determining whether each PWB 70 included in the digital cinema projector 10 is a replaced (that is, newly provided) PWB 70 after the replacement of the PWB 70.

For example, the determination unit 614 determines whether each of the two PWBs 70 is a replaced PWB 70 on the basis of whether the projector serial numbers (first identifier and second identifier) input from the device information acquisition unit 610 and the decrypted projector serial number (third identifier) input from the decryption unit 232 are the same as each other.

In a case where the decrypted projector serial number and the projector serial number are the same as each other, the determination unit 614 determines that the PWB 70 provided with the non-volatile memory 71 in which the projector serial number is stored is not a replaced PWB 70.

On the other hand, in a case where the decrypted projector serial number and the projector serial number are not the same as each other, the determination unit 614 determines that the PWB 70 provided with the non-volatile memory 71 in which the projector serial number is stored is a replaced PWB 70.

In addition, the determination unit 614 has a function of determining the validity of the IMB 20.

For example, the determination unit 614 determines the validity of the IMB 20 on the basis of whether the decrypted IMB serial number input from the decryption unit 232 and the IMB serial number stored in the IMB serial number storage unit 223 are the same as each other.

In a case where the decrypted IB serial number and the IMB serial number are the same as each other, the determination unit 614 determines that the IMB 20 included in the digital cinema projector 10 is valid. That is, the determination unit 614 determines that the IMB 20 has not been spoofed or falsified.

On the other hand, in a case where the decrypted IMB serial number and the IMB serial number are not the same as each other, the determination unit 614 determines that the IMB 20 included in the digital cinema projector 10 is not valid. That is, the determination unit 614 determines that there is a possibility of the IMB 20 being spoofed or falsified.

In addition, the determination unit 614 may determine the validity of the IMB 20 on the basis of whether the decrypted random message input from the decryption unit 232 and the random message input from the random message generation unit 612 are the same as each other.

In a case where the decrypted random message and the random message are the same as each other, the determination unit 614 determines that the IMB 20 included in the digital cinema projector 10 is valid. That is, the determination unit 614 determines that the IMB 20 has not been spoofed or falsified.

On the other hand, in a case where the decrypted random message and the random message are not the same as each other, the determination unit 614 determines that the IMB 20 included in the digital cinema projector 10 is not valid. That is, the determination unit 614 determines that there is a possibility of the IMB 20 being spoofed or falsified.

In addition, the determination unit 614 has a function of determining the validity of the projector serial number.

For example, the determination unit 614 determines the validity of the projector serial number (third identifier) on the basis of whether the decrypted projector serial number (third identifier) input from the decryption unit 232 and the projector serial number (third identifier) input from the device information acquisition unit 610 are the same as each other.

In a case where the decrypted projector serial number and the projector serial number are the same as each other, the determination unit 614 determines that the projector serial number is valid. That is, the determination unit 614 determines that the projector serial number has not been spoofed or falsified.

On the other hand, in a case where the decrypted projector serial number and the projector serial number are not the same as each other, the determination unit 614 determines that the projector serial number is not valid. That is, the determination unit 614 determines that there is a possibility of the projector serial number being spoofed or falsified.

In addition, the determination unit 614 has a function of determining the validity of the IMB serial number.

For example, the determination unit 614 determines the validity of the IMB serial number on the basis of whether the decrypted IMB serial number input from the decryption unit 232 and the IMB serial number input from the device information acquisition unit 610 are the same as each other.

In a case where the decrypted IB serial number and the IMB serial number are the same as each other, the determination unit 614 determines that the IMB serial number is valid. That is, the determination unit 614 determines that the IMB serial number has not been spoofed or falsified.

On the other hand, in a case where the decrypted IMB serial number and the IMB serial number are not the same as each other, the determination unit 614 determines that the IMB serial number is not valid. That is, the determination unit 614 determines that there is a possibility of the IB serial number being spoofed or falsified.

### (6) Update Unit 615

The update unit 615 has a function of updating maintenance information of the non-volatile memory 71. For example, the update unit 615 updates the maintenance information (first maintenance information) stored in the PWB 70 determined by the determination unit 614 to be a replaced PWB 70 with the maintenance information (second maintenance information) stored in the PWB 70 determined by the determination unit 614 not to be a replaced PWB 70. Specifically, the update unit 615 updates the maintenance information stored in the non-volatile memory 71 provided in the newly provided PWB 70 with the maintenance information stored in the non-volatile memory 71 provided in the PWB 70 that has been provided since before the replacement on the basis of the result of determination performed by the determination unit 614.

### <5. Operation>

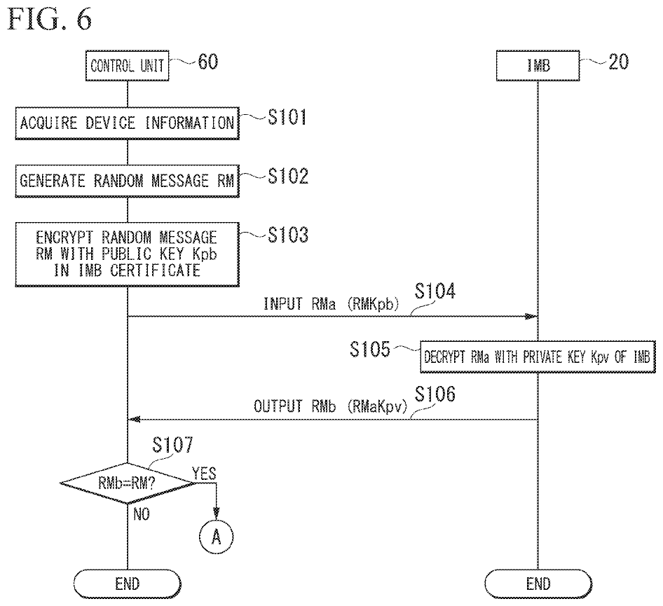

The functional configuration of the control unit 60 of the digital cinema projector 10 according to the present embodiment has been described above. Subsequently, the operation of the digital cinema projector 10 according to the present embodiment will be described with reference to FIGS. 6 to 8.

Meanwhile, the operation to be described below is the operation of the digital cinema projector 10 after the replacement work of replacing one of the two PWBs included in the digital cinema projector 10 is performed. Meanwhile, the two PWBs included in the digital cinema projector 10 after the replacement work are referred to as a PWB I and a PWB II, respectively. In addition, the non-volatile memories provided in the PWB I and the PWB II are referred to as a non-volatile memory I and a non-volatile memory II, respectively.

### (1) Validity Determination Process of IMB 20

First, a validity determination process of the IMB 20 will be described with reference to FIG. 6. FIG. 6 is a sequence diagram illustrating an example of a validity determination process of the IMB 20 according to the present embodiment.

As shown in FIG. 6, first, the device information acquisition unit 610 of the control unit 60 acquires device information (step S101). Specifically, the device information acquisition unit 610 is installed in the digital cinema projector 10 by an operator of the maintenance company 3 and acquires the device information input by the input unit 40.

Next, the random message generation unit 612 of the control unit 60 generates a random message RM (step S102).

Next, the encryption unit 613 of the control unit 60 encrypts the random message RM (step S103). Specifically, the encryption unit 613 encrypts the random message RM generated by the random message generation unit 612 with the public key Kpb in the IMB certificate included in the device information acquired by the device information acquisition unit 610.

The encryption unit 613 then inputs an encrypted random message RMa (RMKpb) to the decryption unit 232 of the IMB 20 (step S104).

Next, the decryption unit 232 decrypts the encrypted random message RMa (step S105). Specifically, the decryption unit 232 decrypts the encrypted random message RMa input from the encryption unit 613 with the private key Kpv stored in the key information storage unit 222.

The decryption unit 232 then outputs a decrypted random message RMb (RMaKpv) to the determination unit 614 of the control unit 60 (step S106).

Next, the determination unit 614 determines the validity of the IMB 20 (step S107). Specifically, the determination unit 614 determines whether the decrypted random message RMb input from the decryption unit 232 and the random message RM input from the random message generation unit 612 are the same as each other.

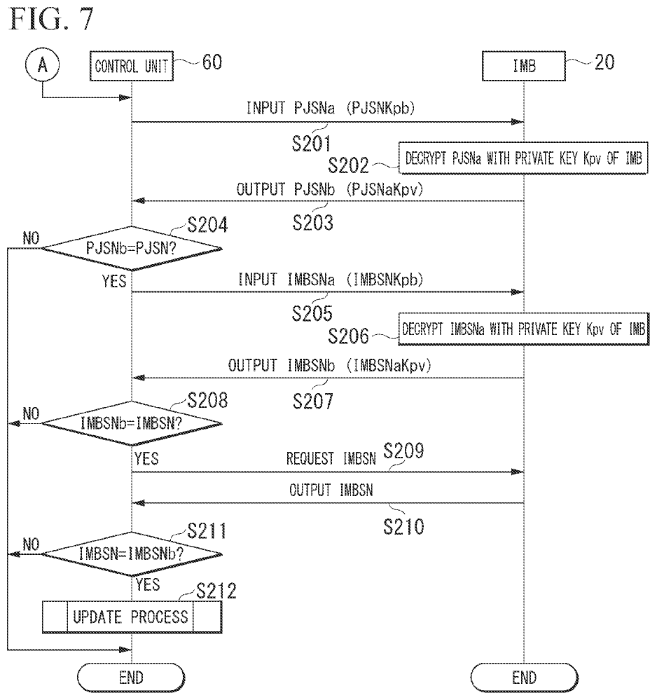

In a case where the decrypted random message RMb and the random message RM are the same as each other (step S107/YES), the determination unit 614 determines that the IMB 20 included in the digital cinema projector 10 is valid, and advances the process to a validity determination process to be described later (from a connector A in FIG. 6 to a connector A in FIG. 7).

On the other hand, in a case where the decrypted random message RMb and the random message RM are not the same as each other (step S107/NO), the determination unit 614 determines that the IMB 20 included in the digital cinema projector 10 is not valid, and ends the process.

### (2) Validity Determination Process of Device Information

Next, the validity determination process of the device information will be described with reference to FIG. 7. FIG. 7 is a sequence diagram illustrating an example of the validity determination process of the device information according to the present embodiment.

As shown in FIG. 7, first, the device information acquisition unit 610 of the control unit 60 inputs the encrypted projector serial number PJSNa (PJSNKpb) included in the acquired device information to the decryption unit 232 of the IMB 20 (step S201).

Next, the decryption unit 232 decrypts the encrypted projector serial number PJSNa (step S202). Specifically, the decryption unit 232 decrypts the encrypted projector serial number PJSNa input from the device information acquisition unit 610 with the private key Kpv stored in the key information storage unit 222.

The decryption unit 232 then outputs the decrypted projector serial number PJSNb (PJSNaKpv) to the determination unit 614 of the control unit 60 (step S203).

Next, the determination unit 614 determines the validity of the projector serial number PJSN (step S204). Specifically, the determination unit 614 determines whether the decrypted projector serial number PJSNb input from the decryption unit 232 and the projector serial number PJSN input from the device information acquisition unit 610 are the same as each other.

In a case where the decrypted projector serial number PJSNb and the projector serial number PJSN are the same as each other (step S204/YES), the determination unit 614 determines that the projector serial number PJSN is valid, and advances the process to step S205.

On the other hand, in a case where the decrypted projector serial number PJSNb and the projector serial number PJSN are not the same as each other (step S204/NO), the determination unit 614 determines that the projector serial number PJSN is not valid, and ends the process.

In a case where the process proceeds to step S205, the device information acquisition unit 610 inputs the encrypted IMB serial number IMBSNa (IMBSNKpb) included in the acquired device information to the decryption unit 232 of the IMB 20 (step S205).

Next, the decryption unit 232 decrypts the encrypted IMB serial number IMBSNa (step S206). Specifically, the decryption unit 232 decrypts the encrypted IMB serial number IMBSNa input from the device information acquisition unit 610 with the private key Kpv stored in the key information storage unit 222.

The decryption unit 232 then outputs the decrypted IMB serial number IMBSNb (IMBSNaKpv) to the determination unit 614 of the control unit 60 (step S207).

Next, the determination unit 614 determines the validity of the IMB serial number IMBSN (step S208). Specifically, the determination unit 614 determines whether the decrypted IMB serial number IMBSNb input from the decryption unit 232 and the IMB serial number IMBSN input from the device information acquisition unit 610 are the same as each other.

In a case where the decrypted IMB serial number IMBSNb and the IMB serial number IMBSN are the same as each other (step S208/YES), the determination unit 614 determines that the IMB serial number IMBSN is valid, and advances the process to step S209.

On the other hand, in a case where the decrypted IMB serial number IMBSNb and the IMB serial number IMBSN are not the same as each other (step S208/NO), the determination unit 614 determines that the IMB serial number IMBBSN is not valid, and ends the process.

In a case where the process proceeds to step S209, the control unit 60 (for example, the determination unit 614) requests the IMB serial number IMBSN stored in the IMB serial number storage unit 223 from the IMB 20 (step S209). Upon receiving the request from the control unit 60, the IMB 20 outputs the IMB serial number IMBSN stored in the IMB serial number storage unit 223 to the determination unit 614 of the control unit 60 (step S210).

Next, the determination unit 614 determines the validity of the IMB 20 again (step S211). Specifically, the determination unit 614 determines whether the IMB serial number IMBSN input from the IMB 20 and the decrypted IMB serial number IMBSNb input from the decryption unit 232 are the same as each other.

In a case where the IB serial number IMBSN and the decrypted IMB serial number IMBSNb are the same as each other (step S211/YES), the determination unit 614 determines that the IMB 20 included in the digital cinema projector 10 is valid, and advances the process to step S212.

On the other hand, in a case where the IMB serial number IMBSN and the decrypted IMB serial number IMBSNb are not the same as each other (step S211/NO), the determination unit 614 determines that the IMB 20 included in the digital cinema projector 10 is not valid, and ends the process.

In a case where the process proceeds to step S211, the control unit 60 performs an update process (step S212). The details of the update process will be described later. After the update process, the process ends.

### (3) Update Process

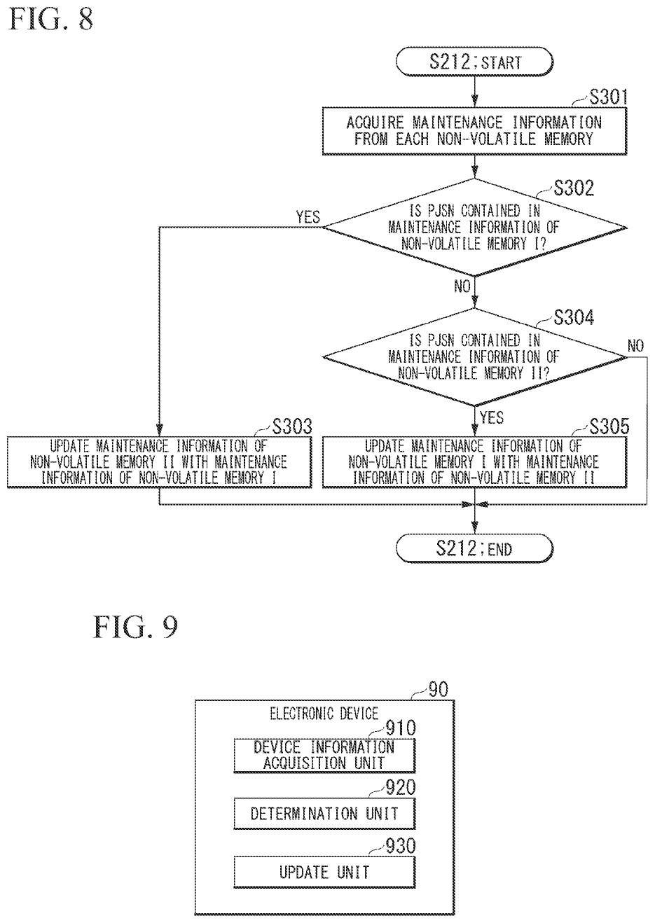

Next, an update process will be described with reference to FIG. 8. FIG. 8 is a flowchart illustrating an example of an update process according to the present embodiment.

As shown in FIG. 8, first, the maintenance information acquisition unit 611 of the control unit 60 acquires maintenance information (step S301). Specifically, the maintenance information acquisition unit 611 acquires maintenance information from each of the non-volatile memory I and the non-volatile memory II provided in two of PWB I and PWB II included in the digital cinema projector 10 after the replacement work.

The device information acquisition unit 610 acquires the projector serial number PJSN from information included in each piece of maintenance information acquired by the maintenance information acquisition unit 611 and outputs it to the determination unit 614. In addition, the maintenance information acquisition unit 611 outputs each piece of acquired maintenance information to the update unit 615.

Next, the determination unit 614 determines whether the maintenance information stored in the non-volatile memory I includes the projector serial number PJSN of the digital cinema projector 10 equipped with the PWB I in which the non-volatile memory I is provided (step S302). Specifically, the determination unit 614 determines whether the projector serial number PJSN acquired from the maintenance information of the non-volatile memory I by the device information acquisition unit 610 and the projector serial number PJSN acquired from the device information database 5 by the device information acquisition unit 610 are the same as each other.

In a case where the projector serial numbers PJSN are the same as each other (step S302/YES), the determination unit 614 determines that the maintenance information stored in the non-volatile memory I includes the projector serial number PJSN of the digital cinema projector 10 equipped with the PWB I in which the non-volatile memory I is provided. That is, the determination unit 614 determines that the PWB I is a PWB that has been provided in the digital cinema projector 10 since before the replacement work (that is, it is not a replaced PWB). From this, it can also be understood that the PWB II is a PWB newly provided in the digital cinema projector 10 through the replacement work (that is, it is a replaced PWB). The determination unit 614 advances the process to step S303.

On the other hand, in a case where the projector serial numbers PJSN are not the same as each other (step S302/NO), the determination unit 614 determines that the maintenance information stored in the non-volatile memory I does not include the projector serial number PJSN of the digital cinema projector 10 equipped with the PWB I in which the non-volatile memory I is provided. The determination unit 614 advances the process to step S304.

In a case where the process proceeds to step S303, the update unit 615 updates the maintenance information of the non-volatile memory II with the maintenance information of the non-volatile memory I (step S303). That is, the update unit 615 updates the maintenance information of the PWB II newly provided in the digital cinema projector 10 through the replacement work with the maintenance information of the PWB I that has been provided in the digital cinema projector 10 since before the replacement work. The maintenance information of the PWB I that has been provided in the digital cinema projector 10 since before the replacement work is the same as the maintenance information held by the PWB removed from the digital cinema projector 10 through the replacement work. Thus, the update unit 615 can transfer the maintenance information held by the PWB removed from the digital cinema projector 10 through the replacement work to the PWB II newly provided in the digital cinema projector 10 through the replacement work. After the update, the update process ends.

In a case where the process proceeds to step S304, the determination unit 614 determines whether the maintenance information stored in the non-volatile memory II includes the projector serial number PJSN of the digital cinema projector 10 equipped with the PWB II in which the non-volatile memory II is provided (step S304). Specifically, the determination unit 614 determines whether the projector serial number PJSN acquired from the maintenance information of the non-volatile memory II by the device information acquisition unit 610 and the projector serial number PJSN acquired from the device information database 5 by the device information acquisition unit 610 are the same as each other.

In a case where the projector serial numbers PJSN are the same as each other (step S304/YES), the determination unit 614 determines that the maintenance information stored in the non-volatile memory II includes the projector serial number PJSN of the digital cinema projector 10 equipped with the PWB II in which the non-volatile memory II is provided. That is, the determination unit 614 determines that the PWB II is a PWB that has been provided in the digital cinema projector 10 since before the replacement work (that is, it is not a replaced PWB). From this, it can also be understood that the PWB I is a PWB newly provided in the digital cinema projector 10 through the replacement work (that is, it is a replaced PWB). The determination unit 614 advances the process to step S305.

On the other hand, in a case where the projector serial numbers PJSN are not the same as each other (step S304/NO), the determination unit 614 determines that the maintenance information stored in the non-volatile memory II does not include the projector serial number PJSN of the digital cinema projector 10 equipped with the PWB II in which the non-volatile memory II is provided. After the determination, the update process ends.

In a case where the process proceeds to step S305, the update unit 615 updates the maintenance information of the non-volatile memory I with the maintenance information of the non-volatile memory II (step S305). That is, the update unit 615 updates the maintenance information of the PWB I newly provided in the digital cinema projector 10 through the replacement work with the maintenance information of the PWB II that has been provided in the digital cinema projector 10 since before the replacement work. The maintenance information of the PWB II that has been provided in the digital cinema projector 10 since before the replacement work is the same as the maintenance information held by the PWB removed from the digital cinema projector 10 through the replacement work. Thus, the update unit 615 can transfer the maintenance information held by the PWB removed from the digital cinema projector 10 through the replacement work to the PWB I newly provided in the digital cinema projector 10 through the replacement work. After the update, the update process ends.

As described above, the digital cinema projector 10 according to the present embodiment is an electronic device including a plurality of PWBs 70 (substrates) provided with the non-volatile memory 71, and includes the device information acquisition unit 610, the determination unit 614, and the update unit 615.

The device information acquisition unit 610 acquires the serial number (first identifier and second identifier) of the digital cinema projector 10 from each of the two PWBs 70, and acquires the serial number (third identifier) of the digital cinema projector 10 from the device information database 5.

The determination unit 614 determines whether each of the two PWBs 70 is a replaced PWB 70 on the basis of whether the serial number (first identifier and second identifier) of the digital cinema projector 10 acquired from each of the two PWBs 70 is the same as the serial number (third identifier) of the digital cinema projector 10 from the device information database 5.

The update unit 615 updates the maintenance information stored in the PWB 70 determined by the determination unit 614 to be a replaced substrate (first maintenance information) with the maintenance information stored in the PWB 70 determined by the determination unit 614 not to be a replaced PWB 70 (second maintenance information).

With such a configuration, the digital cinema projector 10 according to the present embodiment can specify which PWB 70 is a newly provided PWB 70 in a case where any of the plurality of PWBs 70 provided is replaced. Therefore, the digital cinema projector 10 can transfer each piece of information stored in the non-volatile memory 71 of the PWB 70 to be replaced to the non-volatile memory 71 of the newly provided PWB 70.

Thus, when any of substrates in an electronic device including a plurality of substrates provided with a non-volatile memory is replaced, the digital cinema projector 10 (electronic device) according to the present embodiment can transfer information stored in the non-volatile memory provided on the substrate to be replaced to the non-volatile memory provided on the newly provided substrate.

### 6. Modification Example

The embodiment of the present invention has been described above. Subsequently, modification examples of the embodiment of the present invention will be described. Meanwhile, each modification example to be described below may be applied to the embodiment of the present invention independently, or may be applied to the embodiment of the present invention in combination. In addition, each modification example may be applied instead of the configuration described in the embodiment of the present invention, or may be additionally applied to the configuration described in each embodiment of the present invention.

In the above-described embodiment, an example in which the electronic device is a digital cinema projector including an IMB has been described, but there is no limitation to such an example. For example, the electronic device may be a projector without an IMB. The projector is, for example, a general-purpose projector used in homes, offices, and the like.

In addition, in the above-described embodiment, an example in which a CPU having the functions of the control unit 60 is provided in a PWB different from the PWB 70 has been described, but there is no limitation to such an example. For example, a CPU having the functions of the control unit 60 may be provided in each of the PWBs 70. In addition, each of the PWBs 70 may be provided with a CPU having only the function of reading information stored in the non-volatile memory 71 provided in the PWB 70 (for example, the device information acquisition unit 610 and the maintenance information acquisition unit 611) among the functions of the control unit 60, and a PWB different from the PWB 70 may be provided with a CPU having other functions of the control unit 60.

That is, insofar as the information stored in the non-volatile memory 71 can be read, the location where a CPU is provided and the function of the CPU are not particularly limited.

In addition, in the above-described embodiment, an example in which the electronic device includes an IMB and the substrate is replaced using the encrypted information has been described, but there is no limitation to such an example. For example, the electronic device may not include an IMB and the substrate may be replaced without using the encrypted information.

In this case, the determination unit 614 determines whether each PWB 70 included in the digital cinema projector 10 after the replacement of the PWB 70 is a newly provided PWB 70 on the basis of whether the unencrypted projector serial number PJSN acquired by the device information acquisition unit 610 from the device information database 5 and each projector serial number PJSN acquired by the device information acquisition unit 610 from each PWB 70 are the same as each other. Thereby, the determination unit 614 can also determine whether each PWB 70 included in the digital cinema projector 10 after the replacement of the PWB 70 is a newly provided PWB 70 without using the encrypted information.

Meanwhile, all or some of the functions of the digital cinema projector 10 (electronic device) in each of the above-described embodiments may be realized by a computer. In that case, a program for realizing this function may be recorded in a computer readable recording medium, and be realized by causing a computer system to read and execute the program recorded in this recording medium. Meanwhile, the term “computer system” referred to here is assumed to include an OS and hardware such as peripheral devices. In addition, the term “computer readable recording medium” refers to a flexible disk, a magnetooptic disc, a ROM, a portable medium such as a CD-ROM, or a storage device such as a hard disk built into a computer system. Further, the “computer readable recording medium” may include recording mediums that dynamically hold a program during a short period of time like networks such as the Internet or communication lines when a program is transmitted through communication lines such as a telephone line, and recording mediums that hold a program for a certain period of time like a volatile memory inside a computer system serving as a server or a client in that case. In addition, the above-mentioned program may be a program which is used for realizing a portion of the aforementioned functions, may be a program which is capable of realizing the aforementioned functions in combination with programs previously recorded in the computer system, or may be a program which is realized using a programmable logic device such as a field programmable gate array (FPGA).

Hereinbefore, although the embodiments of this invention have been described in detail with reference to the accompanying drawings, specific configurations are not limited to those described above, and various design changes and the like can be made without departing from the scope of this invention.

Further, an electronic device 90 with a minimum configuration according to the embodiment of the present invention will be described with reference to FIG. 9. FIG. 9 is a block diagram illustrating the electronic device 90 with a minimum configuration according to the present embodiment. The electronic device 90 includes at least two substrates.

As shown in FIG. 9, the electronic device 90 includes at least a device information acquisition unit 910, a determination unit 920, and an update unit 930.

The device information acquisition unit 910 acquires a first identifier and a second identifier from each of two substrates, and acquires a third identifier from a database.

The determination unit 920 determines whether each of the two substrates is a replaced substrate on the basis of whether the first identifier and the second identifier are the same as the third identifier.

The update unit 930 updates the first maintenance information stored in the substrate determined by the determination unit 920 to be a replaced substrate with the second maintenance information stored in the substrate determined by the determination unit 920 not to be a replaced substrate.

### REFERENCE SIGNS LIST

1 Movie theater
2 Distribution company
3 Maintenance company
4 Manufacturer
5 Device information database
10 Digital cinema projector
20 IMB
30 Projection unit
40 Input unit
50 Storage unit
60 Control unit
70a, 70b, 70c PWB
71a, 71b, 71c Non-volatile memory
210 Communication unit
220 Storage unit
221 Content information storage unit
222 Key information storage unit
223 IMB serial number storage unit
230 Control unit
231 Content information acquisition unit
232 Decryption unit
233 Content reproduction unit
610, 910 Device information acquisition unit
611 Maintenance information acquisition unit
612 Random message generation unit
613 Encryption unit
614, 920 Determination unit
615, 930 Update unit

What is claimed is:

1. An electronic device with at least two substrates, comprising:
a device information acquisition unit that acquires a first identifier and a second identifier from each of the two substrates and acquires a third identifier from a database;
a determination unit that determines whether each of the two substrates is a replaced substrate on the basis of whether the first identifier and the second identifier are the same as the third identifier; and
an update unit that updates first maintenance information stored in a substrate determined by the determination unit to be a replaced substrate with second maintenance information stored in a substrate determined by the determination unit not to be a replaced substrate.

2. The electronic device according to claim 1, further comprising:
a video device that receives or outputs at least video content,
wherein the device information acquisition unit acquires the third identifier associated with an identifier of the video device in the database.

3. The electronic device according to claim 2, wherein the video device further includes:
a key information storage unit that stores a certificate containing a public key and a private key paired with the public key; and
a decryption unit that decrypts information encrypted with the public key with the private key,
the device information acquisition unit further acquires an encrypted electronic device identifier in which the third identifier is encrypted with the public key from the database,
the decryption unit decrypts the encrypted electronic device identifier acquired from the database with the private key, and
the determination unit determines validity of the third identifier on the basis of whether the third identifier obtained by decryption and the third identifier acquired from the database are the same as each other.

4. The electronic device according to claim 3, wherein the device information acquisition unit further acquires an identifier of the video device and an encrypted video device identifier in which the identifier of the video device is encrypted with the public key from the database,
the decryption unit decrypts the encrypted video device identifier acquired from the database with the private key, and
the determination unit determines validity of the identifier of the video device on the basis of whether the identifier of the video device obtained by decryption and the identifier of the video device acquired from the database are the same as each other.

5. The electronic device according to claim 3, wherein the video device further includes a video device identifier storage unit that stores an identifier of the video device,
wherein the determination unit determines validity of the video device on the basis of whether the identifier of the video device acquired from the database and the identifier of the video device stored in the video device identifier storage unit are the same as each other.

6. The electronic device according to claim 3, further comprising:
a random message generation unit that generates a random message; and
an encryption unit that encrypts information with the public key,
wherein the encryption unit encrypts the generated random message with the public key,
the decryption unit decrypts the encrypted random message with the private key, and
the determination unit determines validity of the video device on the basis of whether the decrypted random message is the same as the generated random message.

7. The electronic device according to claim 2, wherein the video device is an image media block (IMB).

8. The electronic device according to claim 1, wherein the electronic device is a digital cinema projector.

9. A method of controlling an electronic device with at least two substrates, the method comprising:
causing a device information acquisition unit to acquire a first identifier and a second identifier from each of the two substrates and acquire a third identifier from a database;
causing a determination unit to determine whether each of the two substrates is a replaced substrate on the basis of whether the first identifier and the second identifier are the same as the third identifier; and
causing an update unit to update a first maintenance information stored in a substrate determined by the determination unit to be a replaced substrate with second maintenance information stored in a substrate determined by the determination unit not to be a replaced substrate.

10. A non-transitory computer readable storage medium that stores computer-executable programs that, when executed by one or more computers, cause the one or more computers to:
acquire a first identifier and a second identifier from each of the two substrates and acquires a third identifier from a database;
determine whether each of the two substrates is a replaced substrate on the basis of whether the first identifier and the second identifier are the same as the third identifier; and
update first maintenance information stored in a substrate determined to be a replaced substrate with second maintenance information stored in a substrate determined by the determination unit not to be a replaced substrate.
